(19) United States
(12) Patent Application Publication
(10) Pub. No.: US 2005/0062469 A1
(43) Pub. Date: Mar. 24, 2005

(54) System and method for hemisphere disambiguation in electromagnetic tracking systems

(76) Inventor: Peter Traneus Anderson, Andover, MA (US)

Correspondence Address: MCANDREWS HELD & MALLOY, LTD, 500 WEST MADISON STREET, SUITE 3400, CHICAGO, IL, 60661, US

(21) Appl. No.: 10/669,025

(22) Filed: Sep. 23, 2003

(51) Int. Cl. G01B 7/14

(52) U.S. Cl. 324/207.17

(57) ABSTRACT

An electromagnetic tracking system includes a transmitter assembly having a transmitter coil trio, a receiver assembly having a receiver coil trio, and a single coil mounted on one of the receiver assembly and the transmitter assembly. The single coil is positioned a fixed and known distance away from one of the receiver coil trio and the transmitter coil trio. When the receiver assembly is moved relative to the transmitter assembly, relative motion between at least two of the transmitter coil trio, the receiver coil trio and the single coil is asymmetrical, thereby generating different magnetic fields therebetween. The sensed magnetic field, or mutual inductances, between the transmitter assembly and the receiver assembly is different at each position. Thus, each position within a detectable area of the system is distinguishable.

### BACKGROUND OF THE INVENTION

The present invention generally relates to an electromagnetic tracking system. In particular, the present invention relates to a system and method for hemisphere disambiguation with respect to an electromagnetic tracking system.

Many medical procedures involve a medical instrument, such as a drill, a catheter, scalpel, scope, shunt or other tool. In some cases, a medical imaging or video system may be used to provide positioning information for the instrument. However, medical practitioners often do not have the use of medical imaging systems when performing medical procedures. The use of medical imaging systems for instrument tracking may be limited for health and safety reasons (e.g., radiation dosage concerns), financial limitations, physical space restrictions, and other concerns, for example.

Medical practitioners, such as doctors, surgeons, and other medical professionals, often rely upon technology when performing a medical procedure, such as image-guided surgery or examination. A tracking system may provide positioning information for the medical instrument with respect to the patient or a reference coordinate system, for example. A medical practitioner may refer to the tracking system to ascertain the position of the medical instrument when the instrument is not within the practitioner's line of sight. A tracking system may also aid in pre-surgical planning.

The tracking or navigation system allows the medical practitioner to visualize the patient's anatomy and track the position and orientation of the instrument. The medical practitioner may use the tracking system to determine when the instrument is positioned in a desired location. The medical practitioner may locate and operate on a desired or injured area while avoiding other structures. Increased precision in locating medical instruments within a patient may provide for a less invasive medical procedure by facilitating improved control over smaller instruments having less impact on the patient. Improved control and precision with smaller, more refined instruments may also reduce risks associated with more invasive procedures such as open surgery.

Tracking systems may also be used to track the position of items other than medical instruments in a variety of applications. That is, a tracking system may be used in other settings where the position of an instrument in an object or an environment is difficult to accurately determine by visual inspection. For example, tracking technology may be used in forensic or security applications. Retail stores may use tracking technology to prevent theft of merchandise. In such cases, a passive transponder may be located on the merchandise. A transmitter may be strategically located within the retail facility. The transmitter emits an excitation signal at a frequency that is designed to produce a response from a transponder. When merchandise carrying a transponder is located within the transmission range of the transmitter, the transponder produces a response signal that is detected by a receiver. The receiver then determines the location of the transponder based upon characteristics of the response signal.

Tracking systems are also often used in virtual reality systems or simulators. Tracking systems may be used to monitor the position of a person in a simulated environment. A transponder or transponders may be located on a person or object. A transmitter emits an excitation signal and a transponder produces a response signal. The response signal is detected by a receiver. The signal emitted by the transponder may then be used to monitor the position of a person or object in a simulated environment.

Tracking systems may be ultrasound, inertial position, or electromagnetic tracking systems, for example. Electromagnetic tracking systems may employ coils as receivers and transmitters. Typically, an electromagnetic tracking system is configured in an industry-standard coil architecture (ISCA). ISCA uses three colocated orthogonal quasi-dipole transmitter coils, i.e., a transmitter coil trio, and three colocated quasi-dipole receiver coils, i.e., a receiver coil trio. Other systems may use three large, non-dipole, non-colocated transmitter coils with three colocated quasi-dipole receiver coils. Another tracking system architecture uses an array of six or more transmitter coils spread out in space and one or more quasi-dipole receiver coils. Alternatively, a single quasi-dipole transmitter coil may be used with an array of six or more receivers spread out in space.

The ISCA tracker uses a three-axis dipole coil transmitter and a three-axis dipole coil receiver. Each three-axis transmitter or receiver is built so that the three coils exhibit the same effective area, are oriented orthogonally to one another, and are centered at the same point. An example of a dipole coil trio with coils in X, Y, and Z directions spaced approximately equally about a center point is shown in FIG. 1. If the coils are small enough compared to a distance between the transmitter and receiver, then the coil may exhibit dipole behavior. Magnetic fields generated by the trio of transmitter coils may be detected by the trio of receiver coils. For example, U.S. Pat. No. 3,983,474, issued to Kuipers, discloses a system in which magnetic fields generated by a trio of transmitter coils are detected by a trio of receiver coils. Using three approximately concentrically positioned transmitter coils and three approximately concentrically positioned receiver coils, for example, nine parameter measurements may be obtained. From the nine parameter measurements and one known position or orientation parameter, a position and orientation calculation may determine position and orientation information for each of the transmitter coils with respect to the receiver coil trio with three degrees of freedom.

FIG. 2 illustrates a simplified schematic diagram of a receiver coil trio 1 with respect to a transmitter coil trio 2. Typically, the receiver coil trio 1 is secured to a medical instrument, while the transmitter coil trio 2 is secured to a patient (such as through a headset, band, or secured to a portion of the patient's anatomy such as through a bone screw, or the like). The mutual inductances between each of the three transmitter coils (X_{T}, Y_{T}, Z_{T}) in the transmitter coil trio 2 and each of the three receiver coils (X_{R}, Y_{R}, Z_{R}) in the receiver trio 1 are measured. That is, mutual inductances between X_{T} and each of X_{R}, Y_{R}, and Z_{R} are measured. Further, mutual inductances between YT and each of X_{R}, Y_{R}, and Z_{R} are measured. Also, mutual inductances between Z_{T} and each of X_{R}, Y_{R}, and Z_{R} are measured. Thus, a total of nine mutual inductances are measured between the transmitter coil trio 2 and the receiver coil trio 1. The position and orientation of the receiver coil trio 1 with respect to the transmitter coil trio 2 may be calculated from the nine resulting mutual inductances and knowledge of the coil characteristics through common methods known in the art. Overall, the position and orientation of the receiver coil trio 1 with respect to the transmitter coil trio 2 may be calculated from the receiver coil trio 1 sensing the magnetic field generated by the transmitter coil trio 2.

A limitation of a system using the receiver coil trio 1 and the transmitter coil trio 2 is hemisphere ambiguity. Hemisphere ambiguity arises when the receiver coil trio 1 is displaced 180 degrees about the origin and in the same orientation.

FIGS. 3a and 3b show the relationship between a first point 3 with respect to a second point 4 that is located at a position that is diametrically opposite that of the first point. When the receiver coil trio 1 is positioned at the first point 3 (x₁, y₁, z₁) with orientation (az, el, rl), the mutual inductances, or the magnetic field, measured between the receiver coil trio 1 and the transmitter coil trio 2 are exactly the same as when the receiver coil trio 1 is located at the second point 4 (−x₁, −y₁, −z₁) having the same orientation (az, el, rl). For example, the first point 3 may be at position (1 cm, 1 cm, 1 cm), while the second point 4 may be at position (−1 cm, −1 cm, −1 cm) with respect to a center point (0, 0, 0). Typically, the center point is the location of the transmitter coil trio 2. However, the transmitter coil trio 2 may be positioned at the points 3 and 4, while the receiver coil trio 1 is positioned at the origin. The movement between the transmitter coil trio 2 and the receiver coil trio 1 is relative, and mutual inductances and magnetic fields may be measured whether the transmitter coil trio 2 or the receiver coil trio 1 is considered to be positioned at the origin.

One method of nullifying the hemisphere ambiguity is to position two receiver coil trios with respect to a transmitter coil trio. In a first position, one of the receiver coil trios is positioned at (x₁, y₁, z₁), while the second receiver coil trio is at (x₁+1, y₁, z₁). If the entire receiver assembly including the first and second receiver coil trios is moved so that the receiver coil trios maintain the same orientation, different mutual inductances result due to the fixed relationship between the two receiver coil trios.

For example, if the receiver assembly is moved to a second position such that the first receiver coil trio is at (−x₁, −y₁, −z₁) with an orientation (az, el, rl), then the second receiver coil trio is at (−x₁+1, −y₁, −z₁), because the second receiver coil trio is in a fixed relationship with respect to the first receiver coil trio. The position (−x₁+1, −y₁, −z₁) is not diametrically opposite to (x₁+1, y₁, z₁). Because the position of the second receiver coil trio at the second position is not diametrically opposite to the position of the second receiver coil trio at the first position, the measured mutual inductances and magnetic fields between the receiver coil trios and the transmitter coil trio are distinguishable at those positions.

However, with a three coil trio system, the receiver coil trios are typically positioned on the medical instrument. Further, the receiver coil trios are typically positioned a suitable distance apart so that they are distinguishable by the tracking system. That is, if the receiver coil trios are positioned too close together, the tracking system may detect them as a single point, as opposed to two separate points. Spacing the receiver coil trios a suitable distance apart takes up space. The medical instrument may not be large enough to accommodate the two receiver coils positioned a suitable distance apart. Further, the use of additional receiver coil trios on the medical instrument may be bulky, obtrusive, or otherwise awkward.

Thus, a need exists for a more efficient system and method of hemisphere disambiguation within electromagnetic tracking systems.

### BRIEF SUMMARY OF THE INVENTION

Certain embodiments of the present invention provide an electromagnetic tracking system, comprising a transmitter assembly having a transmitter coil trio configured to generate a magnetic field, a receiver assembly having a receiver coil trio configured to sense a generated magnetic field, and a single coil mounted on either the receiver assembly or the transmitter assembly. The single coil is positioned a fixed and known distance away from either the receiver coil trio or the transmitter coil trio. When the receiver assembly is moved relative to the transmitter assembly, relative motion between at least two of the transmitter coil trio, the receiver coil trio and the single coil is asymmetrical, thereby generating and sensing different magnetic fields therebetween. The sensed magnetic fields, or mutual inductances, between the transmitter assembly and the receiver assembly are different at each position. Thus, each position within a detectable area of the system is distinguishable.

If, for example, the transmitter coil trio is considered to be an origin (0, 0, 0) of a three axis coordinate system (having X, Y, and Z axes), the receiver assembly moves relative to the transmitter coil trio. The movement of the receiver coil trio from an initial position to a position that is diametrically opposite from the initial position results in the single coil being located in a position that is a different distance away from one of the transmitter coil trio and the receiver coil trio, such that the relative motion between the transmitter coil trio, receiver coil trio and the single coil is asymmetrical.

If, on the other hand, the receiver coil trio is considered to be the origin, the transmitter assembly moves relative to the receiver coil trio. Movement of the transmitter coil trio from an initial position to a position that is diametrically opposite from the initial position results in the single coil being located in a position that is a different distance away from one of the transmitter coil trio and the receiver coil trio, such that the relative motion between the transmitter coil trio, receiver coil trio and the single coil is asymmetrical.

The single coil may be mounted on the receiver assembly a fixed and known distance away from said receiver coil trio, in which case, the single coil is a single receiver coil configured to sense a generated magnetic field. Optionally, the single coil may be mounted on the transmitter assembly a fixed and known distance away from the transmitter coil trio, in which case, the single coil may be a single transmitter coil configured to generate a magnetic field. However, the single coil positioned on the transmitter assembly may be a receiver single coil configured to sense a generated magnetic field.

The receiver assembly may be positioned on a medical instrument or a patient. For example, the receiver assembly may be mounted on a headset, a flexible band, or directly attached to a portion of a patient's anatomy. Similarly, the transmitter assembly may be positioned on a medical instrument or a patient. Alternatively, the transmitter assembly and the receiver assembly may be used with various other applications in which positional tracking is used.

The receiver assembly may include a plurality of receiver coil trios. Each of the receiver coil trios is positioned a fixed and known distance away from one another, such that the distance between any two receiver coil trios is different. Similarly, the transmitter assembly may include a plurality of transmitter coil trios. Also, additional single coils may be mounted on the transmitter assembly and/or the receiver assembly.

Certain embodiments of the present invention also provide a method of alleviating hemisphere ambiguity in an electromagnetic tracking system. The method includes disposing a transmitter coil trio configured to generate a magnetic field on a first body, disposing a receiver coil trio configured to sense the magnetic field generated by the transmitter coil trio on a second body, and mounting a single receiver coil on the second body a fixed and known distance away from the receiver coil trio so that movement between the transmitter coil trio, the receiver coil trio and the single receiver coil is asymmetrical resulting in different magnetic field measurements detected by the receiver coil trio and the single receiver coil at every position during movement. A constant orientation of the receiver coil trio and the single receiver coil is maintained during movement. The method also includes determining two positions (x, y, z) and (−x, −y, −z), predicting a received field at the two positions using a field model of the single receiver coil, and determining which predicted field better matches the magnetic field detected by the receiver coil trio and the single receiver coil.

### BRIEF DESCRIPTION OF SEVERAL VIEWS OF THE DRAWINGS

FIG. 1 illustrates a dipole coil trio.

FIG. 2 illustrates a simplified schematic diagram of a receiver coil trio with respect to a transmitter coil trio.

FIG. 3a illustrates a three dimensional graphical representation of a first point with respect to a second point, which is located at an opposite position than the first point.

FIG. 3b illustrates a two dimensional graphical representation of a first point with respect to a second point, which is located at an opposite position than the first point.

FIG. 4 illustrates an electromagnetic tracking system according to an embodiment of the present invention.

FIG. 5 illustrates a simplified representation of an electromagnetic tracking system according to an embodiment of the present invention.

FIG. 6 illustrates a simplified representation of an electromagnetic tracking system according to a first alternative embodiment of the present invention.

FIG. 7 illustrates a simplified representation of an electromagnetic tracking system according to a second alternative embodiment of the present invention.

FIG. 8 illustrates a simplified representation of an electromagnetic tracking system according to a third alternative embodiment of the present invention.

FIG. 9 illustrates an electromagnetic tracking system according to a fourth alternative embodiment of the present invention.

FIG. 10 is a flow chart of a method of determining the position of a receiver assembly with respect to a transmitter assembly according to an embodiment of the present invention.

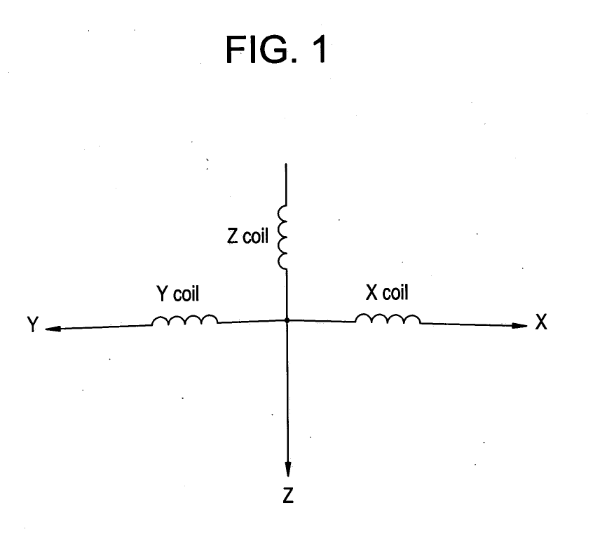

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

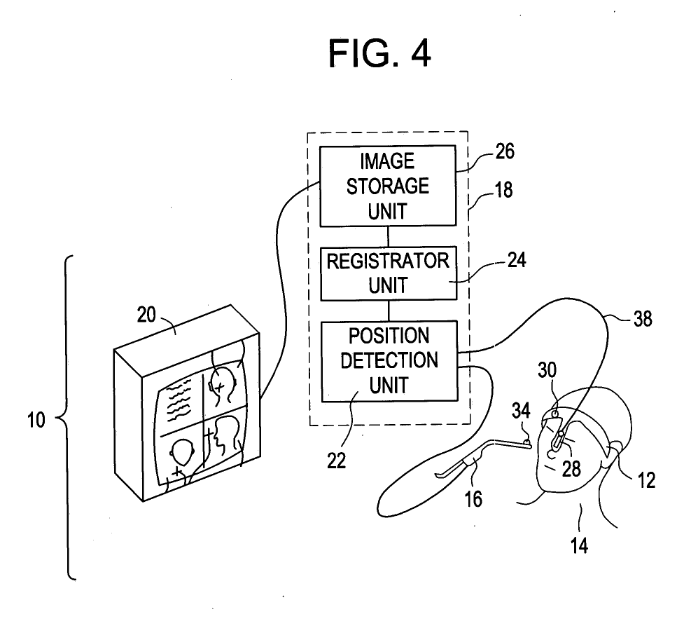

FIG. 4 illustrates an electromagnetic tracking system 10 according to an embodiment of the present invention. The system 10 includes a headset 12 mounted on a patient 14, a medical instrument 16, a control system 18, and a display 20. The control system 18, which is in electrical communication with the medical instrument 16, the headset 12 and the display 20, includes a position detection unit 22, a registration unit 24, and an image storage unit 26. The image storage unit 26 stores sets of prerecorded images such as CAT, MRI, or PET scan images. Each set of images may be taken along, for example, coronal, sagittal or axial directions. The system 10 operates to track the medical instrument 16 with respect to the headset 12 through various methods known in the art.

The system 10 also includes a receiver assembly positioned on the headset 12 defined by a receiver coil trio 28 and a single coil 30 located a fixed distance away from the receiver coil trio 28. The receiver assembly is configured to detect a magnetic field. While the coils of the receiver coil trio 28 are colocated, the single coil 30 is not colocated with the coils of the receiver coil trio 28. The receiver coil trio 28 and the single coil 30 may be positioned anywhere on the headset 12 so long as the two are spaced a suitable distance apart so that both are sensed as separate and distinct points. However, the receiver coil trio 28 and the single coil 30 are within the tracking range of the tracking system 10. That is, the receiver coil trio 28 and the single coil 30 are within a range that is capable of being tracked. The receiver coil trio 28 and the single coil 30 may be wired or wireless. The use of a single coil 30 in place of an additional receiver coil trio increases the amount of available space on the headset 12. That is, the single coil 30 takes up less space than a receiver coil trio.

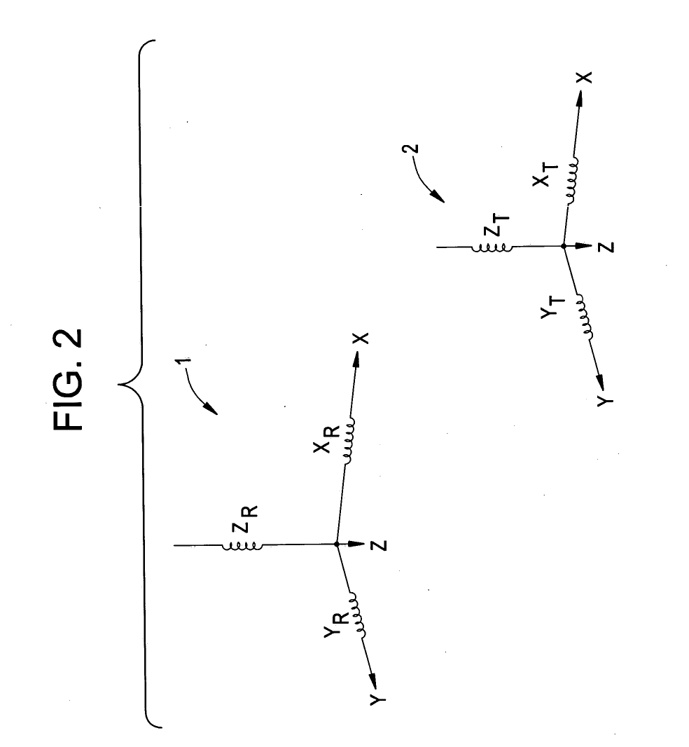

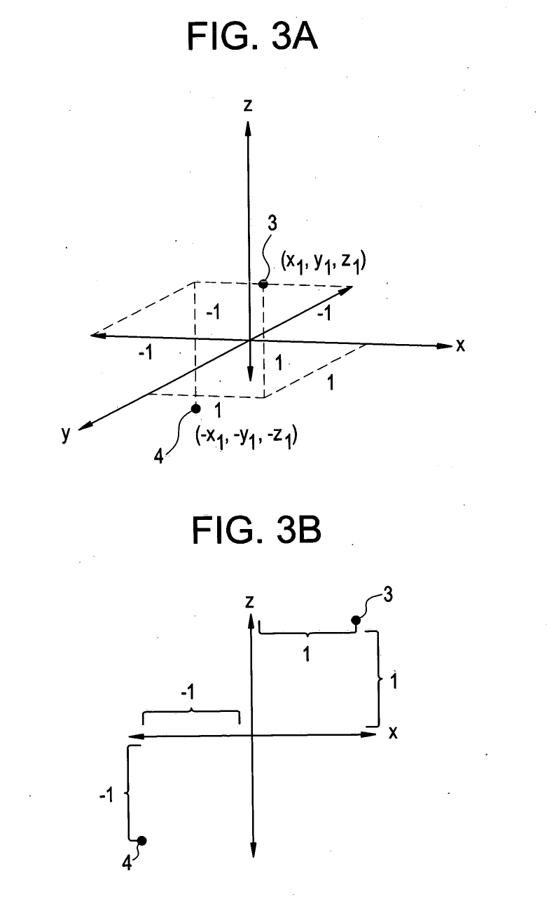

A transmitter assembly defined by a transmitter coil trio 34 is positioned on the medical instrument 16. The transmitter assembly is configured to generate a magnetic field that is detected by the receiver assembly. The transmitter coil trio 34 may be wired or wireless. The transmitter coil trio 34 and the receiver coil trio 28 may be similar to the transmitter coil trio 2 and the receiver coil trio 1, respectively, as shown in FIG. 2.

Optionally, the receiver assembly may be positioned on the medical instrument 16, while the transmitter assembly may be positioned on the headset 12. The headset 12 may include the transmitter coil trio, while the medical instrument 16 includes the receiver coil trio 28 and the single coil 30. Also, alternatively, the receiver assembly may have more than one receiver coil trio, while the transmitter assembly may have more than one transmitter coil trio 34. Further, the receiver coil assembly may use an additional receiver coil trio in place of the single coil 30. Instead of coil trios, the receiver and transmitter assemblies may use dipole coils. Alternatively, tracking elements, such as receiver and transmitter coil trios, and single receiver and transmitter coils, may be affixed, mounted, or otherwise positioned directly to anatomical structures of the patient. For example, a tracking element may be affixed to a vertebrae of the patient 14. Also, alternatively, more than one single coil may be mounted to either the receiver assembly or the transmitter assembly.

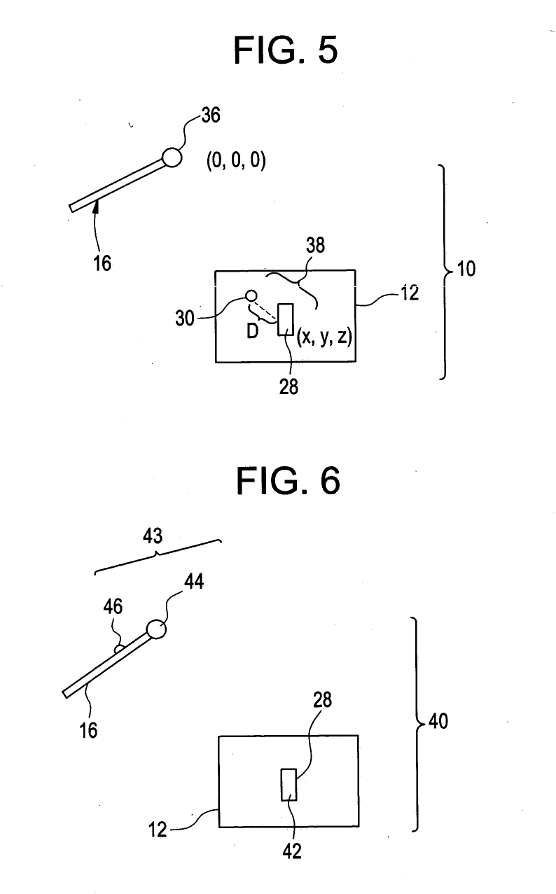

FIG. 5 illustrates a simplified representation of an electromagnetic tracking system 10 according to an embodiment of the present invention. In operation, hemisphere ambiguity is nullified through the use of the receiver assembly 36 located on the medical instrument 16 and the transmitter assembly 38 positioned on the headset 12. As shown in FIG. 5, the receiver coil trio 28 is located a fixed distance (D) from the single coil 30. Thus, as the medical instrument 16 is moved with respect to the headset 12, the measured mutual inductances, or magnetic fields, between the transmitter assembly 38 and the receiver assembly 36 change.

Movement of either the medical instrument 16 or the headset 12 causes relative motion between the two. Thus, for purposes of clarity and simplicity, the position of the receiver assembly 36 will be assumed to remain at an origin (0,0,0). If the position of the receiver assembly 36 is assumed to remain at the origin, movement of the medical instrument 16 causes the position of the transmitter assembly 38 to change with respect to the receiver assembly 36. As shown in FIG. 5, the receiver coil trio 28 is positioned at (x₁, y₁, z₁), while the single coil 30 is positioned a distance D from that position. For example, the single coil 30 may be positioned at (x₁+1, y₁, z₁), (x₁, y₁₊₁, z₁), (x₁+2, y₁, z₁+3), or various other positions such that the fixed distance between the two is sufficient for the system to discern them as two separate points.

As the headset 12 is moved to a position in which the transmitter coil trio 28 is located at (−x₁, −y₁, −z₁) and the orientation of the headset 12 with respect to the medical instrument 16 remains the same, the hemisphere ambiguity is nullified due to the fact the distance D is known. For example, if the distance D is such that the position of the single coil 30 is (x₁+1, y₁, z₁), when the transmitter assembly 38 is moved relative to the receiver assembly 36 such that the position of the transmitter coil trio 28 is at (−x₁, −y₁, −z₁), the single coil 30 is then at position (−x₁+1, −y₁, −z₁). The position (−x₁+1, −y₁, −z₁) is not diametrically opposite to (x₁+1, y₁, z₁). That is, movement from one point to the other is asymmetrical. Thus, the measured mutual inductances and magnetic fields between the transmitter assembly 38 and the receiver assembly 36 at these two positions is not the same. The control system 18 discerns the difference in position between the two positions due to the known and fixed relationship between the receiver coil trio 28 and the single coil 30. Alternatively, the receiver assembly 36 may include more than one single coil 30. Also, the transmitter assembly 38 may include more than one transmitter coil trio 28.

FIG. 6 illustrates a simplified representation of an electromagnetic tracking system 40 according to a first alternative embodiment of the present invention. U.S. Pat. No. 5,803,089, entitled “Position Tracking and Imaging System for Use in Medical Application,” issued to Ferre et al. (the “'089 patent”), discloses an electromagnetic tracking system. The '089 patent is hereby incorporated by reference in its entirety. As shown in FIG. 6, the transmitter assembly 42 includes the transmitter coil trio 28, while the medical instrument 16 includes a receiver assembly 43 having a receiver coil trio 44 and a single receiver coil 46 positioned a known distance away from the receiver coil trio 44. As the medical instrument 16 is moved relative to the headset 12, the mutual inductances are calculated between the receiver assembly 43 and the transmitter assembly 42. Hence, the magnetic fields between the receiver assembly 43 and the transmitter assembly 42 may be measured. Because the distance between the single receiver coil 46 and the receiver coil trio 44 is fixed and known, hemisphere ambiguity is nullified due to the fact that movement of the receiver assembly 43 with respect to the transmitter assembly 42 is asymmetrical. Alternatively, the receiver assembly 43 may include more than one single receiver coil 46. Also, the receiver coil assembly 43 may include more than one receiver coil trio 44.

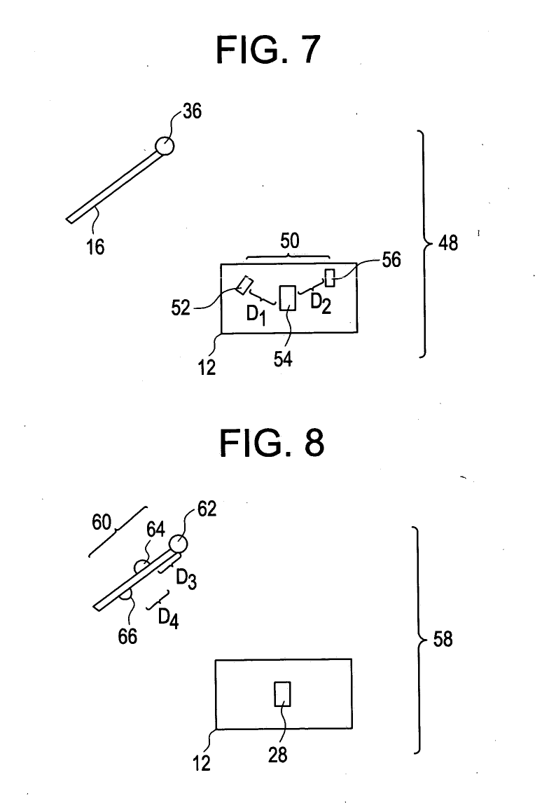

FIG. 7 illustrates a simplified representation of an electromagnetic tracking system 48 according to a second alternative embodiment of the present invention. The system 48 includes the medical instrument 16 having the receiver assembly 36 defined by a receiver coil trio. The headset 12 includes a transmitter assembly 50 defined by first, second and third transmitter coil trios 52, 54, 56. The first transmitter coil trio 52 is a fixed and known distance D1 away from the second transmitter coil trio 54. The second transmitter coil trio 54 is a fixed and known distance D₂ away from the third transmitter coil trio 56. The distance D1 is different in magnitude and orientation than the distance D₂.

Similar to the embodiments above, the relationship between the transmitter coil trios 52, 54, and 56 is such that movement of the headset 12 with respect to the medical instrument, in which the headset 12 remains in a fixed orientation, is asymmetrical. For example, when the transmitter coil trio 54 is positioned at a location that is diametrically opposite from an initial position, the transmitter coils 52 and 56 will not be located in positions that are diametrically opposite from their initial positions, due to the fixed and known distances between the transmitter coil trios 52, 54, and 56.

FIG. 8 illustrates a simplified representation of an electromagnetic tracking system 58 according to a third alternative embodiment of the present invention. The system 48 includes the medical instrument 16 having the receiver assembly 60 defined by first, second, and third receiver trio coils 62, 64 and 66. The first receiver coil trio 62 is a fixed and known distance D₃ away from the second receiver coil trio 64. The second receiver coil trio 64 is a fixed and known distance D₄ away from the third receiver coil trio 66. The distance D₃ is different in magnitude and orientation than the distance D₄.

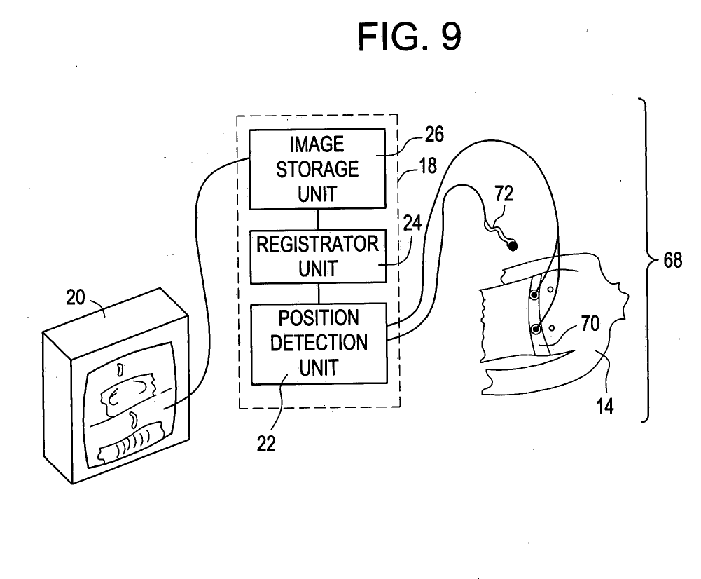

FIG. 9 illustrates an electromagnetic tracking system 68 according to a fourth alternative embodiment of the present invention. The system 68 includes a band 70 positioned around a chest of a patient 14, a medical instrument 72, a control system 18, and a display 20. The control system 18, which is in electrical communication with the medical instrument 72, the band 70, and the display 20, includes a position detection unit 22, a registration unit 24, and an image storage unit 26. The system 70 operates to track the medical instrument 72 with respect to the band 70 through various methods known in the art.

The system 68 is similar to the systems described above except that a band 70 is used instead of a headset. Tracking elements, such as receiver and transmitter coil trios, and single receiver and transmitter coils, may be positioned on the band 70 and the medical instrument 72 as described above with respect to FIGS. 4-8. Alternatively, tracking elements may be affixed, mounted, or otherwise positioned directly to anatomical structures of the patient. For example, a tracking element may be affixed to a vertebra of the patient 14.

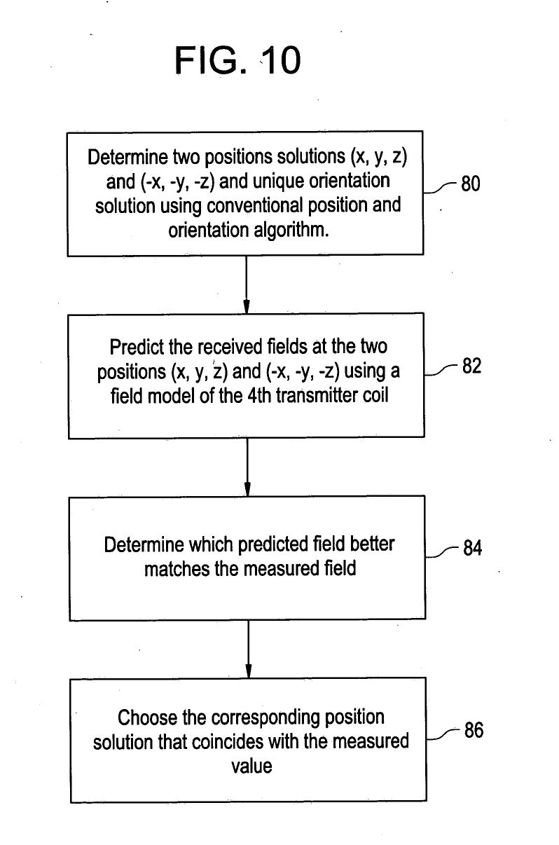

FIG. 10 is a flow chart of a method of determining the position of a receiver assembly with respect to a transmitter assembly according to an embodiment of the present invention. At 80, the two position solutions (x, y, z) and (−x, −y, −z) and the unique orientation solution (az, el, rl) are determined using the conventional position and orientation algorithm. At this step, information from the fourth transmitter coil may be ignored. Instead, the positions between the three coils of a receiver coil trio positioned on one of a medical instrument or a patient and the three coils of a transmitter coil trio positioned on the other of the medical instrument or the patient is determined.

Next, at 82, the received fields (or mutual inductances) at the two positions (x, y, z) and (−x-, −y, −z) are predicted using a field model of the fourth transmitter coil. Because the fourth transmitter coil is positioned a fixed and known distance away from either the receiver coil trio or the transmitter coil trio, relative motion of the fourth transmitter coil when one of the transmitter coil trio or receiver coil trio is moved to a position that is diametrically opposite from an initial position is asymmetrical. That is, while the transmitter coil trio or the receiver coil trio is moved to a position that is diametrically opposite, the position of the fourth transmitter coil is not diametrically opposite from its initial position. Optionally, the fourth transmitter coil may be a fourth receiver coil.

At step 84, a determination is made as to which predicted field better matches the measured field. For example, a plurality of plausible predictions or estimates may exist, but only one measured field (or one set of measured mutual inductances) exists. Thus, a control system or a user may determine which prediction is closest to the measured field (or set of measured mutual inductances). Finally, at 86, the corresponding prediction that coincides or matches with the measurements is chosen.

Thus, embodiments of the present invention provide a more efficient system and method of hemisphere disambiguation within electromagnetic tracking systems. Further, certain embodiments of the present invention provide a less obtrusive and bulky system of alleviating hemisphere ambiguity within electromagnetic tracking systems.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An electromagnetic tracking system, comprising:
a transmitter assembly having a transmitter coil trio;
a receiver assembly having a receiver coil trio;
a single coil mounted on one of said receiver assembly and said transmitter assembly, said single coil being positioned a fixed and known distance away from one of said receiver coil trio and said transmitter coil trio, wherein when said receiver assembly is moved relative to said transmitter assembly, relative motion between at least two of said transmitter coil trio, said receiver coil trio and said single coil is asymmetrical.

2. The electromagnetic tracking system of claim 1, wherein said transmitter coil trio is considered to be an origin, wherein said receiver assembly moves relative to said transmitter coil trio, and wherein movement of said receiver coil trio from an initial position to a position that is diametrically opposite from said initial position results in said single coil being located in a position that is a different distance away from one of said transmitter coil trio and said receiver coil trio, such that said relative motion between said transmitter coil trio, receiver coil trio and said single coil is asymmetrical.

3. The electromagnetic tracking system of claim 1, wherein said receiver coil trio is considered to be an origin, wherein said transmitter assembly moves relative to said receiver coil trio, and wherein movement of said transmitter coil trio from an initial position to a position that is diametrically opposite from said initial position results in said single coil being located in a position that is a different distance away from one of said transmitter coil trio and said receiver coil trio, such that said relative motion between the transmitter coil trio, receiver coil trio and single coil is asymmetrical.

4. The electromagnetic tracking system of claim 1, wherein said single coil is mounted on said receiver assembly a fixed and known distance away from said receiver coil trio.

5. The electromagnetic tracking system of claim 1, wherein said single coil is mounted on said transmitter assembly a fixed and known distance away from said transmitter coil trio.

6. The electromagnetic tracking system of claim 1, wherein said receiver assembly is positioned on one of a medical instrument and a patient and said transmitter assembly is positioned on the other of said medical instrument and the patient.

7. The electromagnetic tracking system of claim 1, wherein said receiver assembly comprises a plurality of receiver coil trios, each of said receiver coil trios being positioned a fixed and known distance away from one another, and wherein a distance between any two receiver coil trios is different.

8. The electromagnetic tracking system of claim 1, wherein said transmitter assembly comprises a plurality of transmitter coil trios, each of said transmitter coil trios being positioned a fixed and known distance away from one another, and wherein a distance between any two transmitter coil trios is different.

9. The electromagnetic tracking system of claim 1, further comprising additional single coils mounted on at least one of said transmitter assembly and said receiver assembly, wherein each of said single coils is mounted a different fixed distance away from one of said receiver coil trio and said transmitter coil trio.

10. An electromagnetic tracking system that is configured to nullify hemisphere ambiguity, comprising:
a transmitter assembly having a transmitter coil trio configured to generate a magnetic field;
a receiver assembly having a receiver coil trio configured to sense the magnetic field;
a single receiving coil mounted on said receiver assembly and positioned a fixed and known distance away from said receiver coil trio, said single receiving coil configured to sense the magnetic field, wherein when said receiver assembly is moved relative to said transmitter assembly, while maintaining a constant orientation, to a position in which one of said receiver coil trio and said single receiving coil is located at a position that is diametrically opposite from an initial position of said one of said receiver coil trio and said single receiving coil, the other of said receiver coil trio and said single receiving coil is located at a position that is not diametrically opposite from an initial position of said other of said receiver coil trio and said single receiving coil.

11. The electromagnetic tracking system of claim 10, wherein said receiver assembly is positioned on one of a medical instrument and a patient and said transmitter assembly is positioned on the other of said medical instrument and the patient.

12. The electromagnetic tracking system of claim 10, wherein said receiver assembly comprises a plurality of receiver coil trios, each of said receiver coil trios being positioned a fixed and known distance away from one another, and wherein a distance between any two receiver coil trios is different.

13. The electromagnetic tracking system of claim 10, wherein said transmitter assembly comprises a plurality of transmitter coil trios, each of said transmitter coil trios being positioned a fixed and known distance away from one another, and wherein a distance between any two transmitter coil trios is different.

14. The electromagnetic tracking system of claim 10, further comprising at least one additional single receiving coil mounted on said receiver assembly, wherein each of said single receiving coils is mounted a different fixed distance away from said receiver coil trio.

15. A method of alleviating hemisphere ambiguity in an electromagnetic tracking system, comprising:
disposing a transmitter coil trio configured to generate a magnetic field on a first body;
disposing a receiver coil trio configured to sense the magnetic field generated by the transmitter coil trio on a second body;
mounting a single receiver coil on the second body a fixed and known distance away from the receiver coil trio so that movement between the transmitter coil trio, the receiver coil trio and the single receiver coil is asymmetrical resulting in different magnetic field measurements by the receiver coil trio and the single receiver coil at every position during movement.

16. The method of claim 15, further comprising:
determining two positions (x, y, z) and (−x, −y, −z);
predicting a received field at the two positions using a field model of the single receiver coil; and
determining which predicted field better matches the magnetic field detected by the receiver coil trio and the single receiver coil.

17. The method of claim 15, further comprising maintaining a constant orientation of the receiver coil trio and the single receiver coil during movement.

18. The method of claim 15, wherein the first body is one of a medical instrument and a patient, and the second body is the other of the medical instrument and the patient.

19. The method of claim 15, wherein said disposing a transmitter coil trio comprises disposing a plurality of transmitter coil trios on the first body.

20. The method of claim 15, wherein said disposing a receiver coil trio comprises disposing a plurality of receiver coil trios on the second body.
